(19) United States
(12) Patent Application Publication
(10) Pub. No.: US 2025/0124190 A1
(43) Pub. Date: Apr. 17, 2025

(54) LINEAR MOTOR DESIGN VARIABLE VERIFICATION METHOD AND LINEAR MOTOR DESIGN VARIABLE OPTIMIZATION METHOD

(71) Applicant: UIF (University Industry Foundation), Yonsei University, Seoul (KR)

(72) Inventors: Jun Young YOON, Seoul (KR); Jae Hyun KIM, Incheon (KR); Sang Min LEE, Seoul (KR); Yoon Sik KWON, Seoul (KR); Bo Min KANG, Seoul (KR); Jung Min PARK, Seoul (KR); Jong Min SUNG, Seoul (KR); Byung Wook JEON, Seoul (KR); Kang Hee LEE, Seoul (KR)

(73) Assignee: UIF (University Industry Foundation), Yonsei University, Seoul (KR)

(21) Appl. No.: 18/904,900

(22) Filed: Oct. 2, 2024

(30) Foreign Application Priority Data
Oct. 16, 2023 (KR) 10-2023-0138044

(51) Int. Cl. G06F 30/20; G06F 30/15; G06F 111/10; G06F 119/14

(52) U.S. Cl. CPC G06F 30/20; G06F 30/15; G06F 2111/10; G06F 2119/14

(57) ABSTRACT

A linear motor design variable verification method and a linear motor design variable optimization method are disclosed. The linear motor design variable verification method includes a first step of deriving a magnetic permeability matrix of a linear motor from a linear motor design variable; a second step of deriving a Maxwell matrix of the linear motor from the magnetic permeability matrix of the linear motor via LU decomposition; a third step of deriving, from the Maxwell matrix of the linear motor, at least one verification target physical quantity selected from a group including a force of the linear motor, a magnetic flux linkage passing through each of coils of a stator of the linear motor, a counter electromotive force of the linear motor, and an inductance of the linear motor; and a fourth step of comparing the derived verification target physical quantity with a predetermined reference value, and determining whether a target verification condition is satisfied, based on the comparing result.

### CROSS-REFERENCE TO RELATED APPLICATION

This application claims priority from Korean Patent Application No. 10-2023-0138044 filed on Oct. 16, 2023 in the Korean Intellectual Property Office, and all the benefits accruing therefrom under 35 U.S.C. 119, the contents of which in its entirety are herein incorporated by reference.

### BACKGROUND

### Field

The present disclosure relates to a linear motor design variable verification method and a linear motor design variable optimization method.

### Description of Related Art

In industries that require high acceleration and high output characteristics for high yield, an iron core linear motor is often used. In the iron core linear motor, a wave of a force as caused by structural characteristics of the motor occur. Therefore, a method for predicting electromagnetic characteristics according to the design variable of the motor was required in an early design stage.

Accordingly, there have been many technologies for calculating the Maxwell equation of the static magnetic field in the form of a simultaneous partial differential equation as the governing equation in the electromagnetic problem, using a numerical calculation method such as the finite element method. In motor analysis using the numerical calculation method, the structural shape of the motor should be divided into a large number of nodes and elements (mesh), such that there is a problem that the analysis takes a long time when calculating the equation while changing various design variables.

### SUMMARY

One purpose of the present disclosure is to provide a rapid linear motor design variable verification method.

Another purpose of the present disclosure is to provide a rapid linear motor design variable optimization method.

Still another purpose of the present disclosure is to provide a linear motor manufactured according to a linear motor design variable verified and/or optimized via the verification method and/or optimization method.

In particular, in order to solve the problem of the prior art, a purpose of the present disclosure is to provide a new type of analysis technique in which the task of predicting the electromagnetic characteristics of a motor in the prototype stage can be performed quickly by providing frequency-based modeling based on a magnetic permeability matrix.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

A first aspect of the present disclosure provides a linear motor design variable verification method comprising: a first step of deriving a magnetic permeability matrix of a linear motor from a linear motor design variable based on a following Equation (1); a second step of deriving a Maxwell matrix of the linear motor from the magnetic permeability matrix of the linear motor via LU decomposition; a third step of deriving, from the Maxwell matrix of the linear motor, at least one verification target physical quantity selected from a group including a force of the linear motor, a magnetic flux linkage passing through each of coils of a stator of the linear motor, a counter electromotive force of the linear motor, and an inductance of the linear motor; and a fourth step of comparing the derived verification target physical quantity with a predetermined reference value, and determining whether a target verification condition is satisfied, based on the comparing result:

$$\{ \begin{matrix}μ ( x , y ) cos ( {m}_{i} x ) cos ( {n}_{j} y ) = {\sum }_{k , l} {α}_{( l , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( l , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$

where x and y denote a x-coordinate and a y-coordinate of the linear motor, respectively,
μ denotes a magnetic permeability of a material of the linear motor,
mᵢ and nⱼ are defined as (2π/λₓ)i and (2π/λ_{y})j, respectively,
mₖ and nₗ are defined as (2π/λₓ)k and (2π/λ_{y})l, respectively,
λₓ and λ_{y} denote fundamental periods of a trigonometric function in an x direction and a y direction, respectively,
each of α, β, γ, ξ, ε, and ρ denotes a two-dimensional magnetic permeability matrix.

In accordance with some embodiments of the linear motor design variable verification method, the LU decomposition of the second step is performed based on a following Equation (2):

$$\begin{matrix}{H}_{x} = - MT {λ}_{cc}^{- 1} ( e \text{?} \text{?} \text{?} 𝕃 - e \text{?} \text{?} \text{?} 𝕄 ) sin ( {m}_{i} x ) cos ( {n}_{j} y ) - MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {H}_{y} = - NT {λ}_{cc}^{- 1} ( e \text{?} \text{?} \text{?} 𝕃 - e \text{?} \text{?} \text{?} 𝕄 ) cos ( {m}_{i} x ) sin ( {n}_{j} y ) + NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {H}_{z} = T ( e \text{?} \text{?} \text{?} 𝕃 + e \text{?} \text{?} \text{?} 𝕄 ) cos ( {m}_{i} x ) cos ( {n}_{j} y ) + U ( e \text{?} \text{?} \text{?} ℕ - e \text{?} \text{?} \text{?} 𝕆 ) cos ( {m}_{i} x ) sin ( {n}_{j} y ) \\ {B}_{x} = - {ε}^{- 1} MT {λ}_{cc}^{- 1} ( e \text{?} \text{?} 𝕃 - e \text{?} \text{?} \text{?} 𝕄 ) sin ( {m}_{i} x ) cos ( {n}_{j} y ) - {ρ}^{- 1} MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {B}_{y} = - {ξ}^{- 1} NT {λ}_{cc}^{- 1} ( e \text{?} \text{?} 𝕃 - e \text{?} \text{?} \text{?} 𝕄 ) cos ( {m}_{i} x ) sin ( {n}_{j} y ) + {γ}^{- 1} NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {B}_{z} = α T ( e \text{?} \text{?} \text{?} 𝕃 + e \text{?} \text{?} \text{?} 𝕄 ) cos ( {m}_{i} x ) cos ( {n}_{j} y ) + β U ( e \text{?} \text{?} \text{?} ℕ + e \text{?} \text{?} \text{?} 𝕆 ) cos ( {m}_{i} x ) sin ( {n}_{j} y )\end{matrix}$$

$$\text{?} \text{indicates text missing or illegible when filed}$$

where Hₓ, H_{y}, and H_{z} denote magnetic field strengths in the x direction, the y direction, and a z direction, respectively,
Bₓ, B_{y}, and B_{z} denote magnetic flux densities in the x direction, the y direction, and the z direction, respectively,
M and N denote diagonal matrices having the mᵢ and nⱼ as diagonal elements, respectively,
T and λ_{cc} denote an eigenvector matrix and an eigenvalue matrix of {α⁻¹(Mε⁻¹M+Nξ⁻¹N)}^{1/2}, respectively,
U and λ_{cs} denote an eigenvector matrix and an eigenvalue matrix of {β⁻¹(Mρ⁻¹M+Nγ⁻¹N)}^{1/2}, respectively,
each of L, M, N, and O denotes a magnetic field constant of the Maxwell matrix to be derived.

In accordance with some embodiments of the linear motor design variable verification method, in the third step, the force of the linear motor is derived based on a following Equation (3):

$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$

where Fₓ, F_{y}, and F_{z} denote forces of the linear motor in the x direction, the y direction, and a z direction, respectively,
T denotes a Maxwell stress tensor,
Bₓ, B_{y}, and B_{z} denote magnetic flux densities in the x direction, the y direction, and the z direction, respectively,
μ₀ denotes a magnetic permeability in vacuum.

In accordance with some embodiments of the linear motor design variable verification method, in the third step, the magnetic flux linkage passing through each of coils of the stator of the linear motor is derived based on a following Equation (4):

$$ϕ = \int B \cdot dA = \int ( ▽ \times A ) \cdot dA = ∮ A \cdot dl \qquad Equation ( 4 )$$

where ϕ denotes a magnetic flux passing through each coil,
B denotes a magnetic flux density,
A denotes a magnetic vector potential,
∇×A denotes a magnetic vector potential rotation value.

In accordance with some embodiments of the linear motor design variable verification method, in the third step, the counter electromotive force of the linear motor is derived based on a following Equation (5):

$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$

where V_{bemf} denotes a counter electromotive force (back-EMF) generated in the stator due to a relative motion of the stator and mover of the linear motor,
t denotes a time,
yᵣ denotes a moving distance,
v denotes a velocity of the mover of the linear motor.

In accordance with some embodiments of the linear motor design variable verification method, in the third step, the inductance of the linear motor is derived based on a following Equation (6),

$$L = ϕ I \qquad Equation ( 6 )$$

where L denotes an inductance of the stator of the linear motor,
I denotes a magnitude of a current applied to the stator of the linear motor.

A second aspect of the present disclosure provides a linear motor design variable optimization method comprising: a first step of deriving a magnetic permeability matrix of each of two or more virtual linear motors from a design variable of each of the two or more virtual linear motors, based on a following Equation (1); a second step of deriving a Maxwell matrix of each virtual linear motor from the magnetic permeability matrix of each virtual linear motor via LU decomposition; a third step of deriving, from the Maxwell matrix of each virtual linear motor, at least one verification target physical quantity selected from a group including a force of each virtual linear motor, a magnetic flux linkage passing through each of coils of a stator of each virtual linear motor, a counter electromotive force of each virtual linear motor, and an inductance of each virtual linear motor; and a fourth step of comparing the verification target physical quantity of each virtual linear motor with a target design value, and selecting the virtual linear motor having the verification target physical quantity satisfying a target verification condition of the design variable among the two or more virtual linear motors, based on the comparing result, wherein the linear motor design variable optimization method includes repeating the first step to the fourth step on two or more virtual linear motors including the linear motor selected in the fourth step at least one time:

$$\{ \begin{matrix}μ ( x , y ) cos ( {m}_{i} x ) cos ( {n}_{j} y ) = {\sum }_{k , l} {α}_{( i , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( i , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$

where x and y denote a x-coordinate and a y-coordinate of the linear motor, respectively,
μ denotes a magnetic permeability of a material of the linear motor,
mᵢ and nⱼ are defined as (2π/λₓ)i and (2π/λ_{y})j, respectively,
mₖ and nₗ are defined as (2π/λₓ)k and (2π/λ_{y})l, respectively,
λₓ and λ_{y} denote fundamental periods of a trigonometric function in an x direction and a y direction, respectively,
each of α, β, γ, ξ, ε, and ρ denotes a two-dimensional magnetic permeability matrix.

In accordance with some embodiments of the linear motor design variable optimization method, the LU decomposition of the second step is performed based on a following Equation (2):

### Equation (2)

$$\begin{matrix}{H}_{y} = - MT {λ}_{cc}^{- 1} ( e \text{?} \text{?} \text{?} 𝕃 - e \text{?} \text{?} \text{?} 𝕄 ) sin ( {m}_{i} x ) cos ( {n}_{j} y ) - MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {H}_{y} = - NT {λ}_{cc}^{- 1} ( e \text{?} \text{?} \text{?} 𝕃 - e \text{?} \text{?} \text{?} 𝕄 ) cos ( {m}_{i} x ) sin ( {n}_{j} y ) + NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {H}_{z} = T ( e \text{?} \text{?} \text{?} 𝕃 + e \text{?} \text{?} \text{?} 𝕄 ) cos ( {m}_{i} x ) cos ( {n}_{j} y ) + U ( e \text{?} \text{?} \text{?} ℕ + e \text{?} \text{?} \text{?} 𝕆 ) cos ( {m}_{i} x ) sin ( {n}_{j} y ) \\ {B}_{x} = - {ε}^{- 1} MT {λ}_{cc}^{- 1} ( e \text{?} \text{?} 𝕃 - e \text{?} \text{?} \text{?} 𝕄 ) sin ( {m}_{i} x ) cos ( {n}_{j} y ) - {ρ}^{- 1} MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {B}_{y} = - {ξ}^{- 1} NT λ \text{?} ( e \text{?} \text{?} 𝕃 - e \text{?} \text{?} \text{?} 𝕄 ) cos ( {m}_{i} x ) sin ( {n}_{j} y ) + {γ}^{- 1} NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {B}_{z} = α T ( e \text{?} \text{?} \text{?} 𝕃 + e \text{?} \text{?} \text{?} 𝕄 ) cos ( {m}_{i} x ) cos ( {n}_{j} y ) - βU ( e \text{?} \text{?} \text{?} ℕ - e \text{?} \text{?} \text{?} 𝕆 ) cos ( {m}_{i} x ) sin ( {n}_{j} y )\end{matrix}$$

$$\text{?} \text{indicates text missing or illegible when filed}$$

where Hₓ, H_{y}, and H_{z} denote magnetic field strengths in the x direction, the y direction, and a z direction, respectively,
Bₓ, B_{y}, and B_{z} denote magnetic flux densities in the x direction, the y direction, and the z direction, respectively,
M and N denote diagonal matrices having the mᵢ and nⱼ as diagonal elements, respectively,
T and λ_{cc} denote an eigenvector matrix and an eigenvalue matrix of {α⁻¹(Mε⁻¹M+Nξ⁻¹N)}^{1/2}, respectively,
U and λ_{cs} denote an eigenvector matrix and an eigenvalue matrix of {β⁻¹(Mρ⁻¹M+Nγ⁻¹N)}^{1/2}, respectively,
each of L, M, N, and O denotes a magnetic field constant of the Maxwell matrix to be derived.

In accordance with some embodiments of the linear motor design variable optimization method, in the third step, the force of the linear motor is derived based on a following Equation (3):

$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$

where Fₓ, F_{y}, and F_{z} denote forces of the linear motor in the x direction, the y direction, and a z direction, respectively,
T denotes a Maxwell stress tensor,
Bₓ, B_{y}, and B_{z} denote magnetic flux densities in the x direction, the y direction, and the z direction, respectively,
μ₀ denotes a magnetic permeability in vacuum.

In accordance with some embodiments of the linear motor design variable optimization method, in the third step, the magnetic flux linkage passing through each of coils of the stator of the linear motor is derived based on a following Equation (4):

$$ϕ = \int B \cdot dA = \int ( ▽ \times A ) \cdot dA = ∮ A \cdot dl \qquad Equation ( 4 )$$

where ϕ denotes a magnetic flux passing through each coil,
B denotes a magnetic flux density,
A denotes a magnetic vector potential,
∇×A denotes a magnetic vector potential rotation value.

In accordance with some embodiments of the linear motor design variable optimization method, in the third step, the counter electromotive force of the linear motor is derived based on a following Equation (5):

$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$

where V_{bemf} denotes a counter electromotive force (back-EMF) generated in the stator due to a relative motion of the stator and mover of the linear motor,
t denotes a time,
yᵣ denotes a moving distance,
v denotes a velocity of the mover of the linear motor.

In accordance with some embodiments of the linear motor design variable optimization method, in the third step, the inductance of the linear motor is derived based on a following Equation (6),

$$L = ϕ I \qquad Equation ( 6 )$$

where L denotes an inductance of the stator of the linear motor,
I denotes a magnitude of a current applied to the stator of the linear motor.

The linear motor design variable verification method according to an embodiment of the present disclosure may quickly and accurately verify the design variable of the linear motor to derive the possibility of operation of the motor and the possibility of achieving the target performance.

The linear motor design variable optimization method according to an embodiment of the present disclosure may quickly and accurately optimize the design variable of the linear motor to search for the design variable of the linear motor that may achieve the target performance.

The linear motor according to an embodiment of the present disclosure may be designed to have the target performance via the verification method and/or the optimization method.

In particular, the iron core linear motor is adopted to implement a linear motion that generates high thrust in various applications. Generally, it is essential to quickly and accurately predict the electromagnetic characteristics of the prototype motor in the initial design stage. In accordance with the present disclosure, the analytical solution of the Maxwell equation of the static magnetic field may be derived based on the magnetic permeability matrix and may be used for the motor analysis. Thus, the motor analysis result may have an accuracy of 95% or greater compared to a commercial finite element analysis program. Furthermore, the method according to the present disclosure does not require the process of dividing the structure of the motor to be analyzed into nodes and elements, thereby significantly reducing the analysis time compared to the commercial finite element analysis program. The high-speed electromagnetic analysis method of the present disclosure has the effect of enabling faster motor design while maintaining the accuracy of the design equivalent to the accuracy of the design method using the conventional numerical calculation-based finite element analysis program.

The effects of the present disclosure are not limited to the effects as mentioned above, and other effects not mentioned above will be clearly understood by those skilled in the art from following descriptions.

In addition to the above-described effects, the specific effects of the present disclosure are described below while describing specific details for implementing the embodiments of the present disclosure.

### BRIEF DESCRIPTION OF DRAWINGS

FIG. 1 is a block diagram showing an electromagnetic analysis model used in a linear motor design variable verification method according to an embodiment of the present disclosure.

FIG. 2 is a linear motor verifying a design variable through a linear motor design variable verification method according to an embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a magnitude, a ratio, an angle, a number, etc. disclosed in the drawings for illustrating embodiments of the present disclosure are illustrative, and embodiments of the present disclosure are not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of associated listed items. Expression such as “at least one of” when preceding a list of elements may modify the entire list of elements and may not modify the individual elements of the list. In interpretation of numerical values, an error or tolerance therein may occur even when there is no explicit description thereof.

In descriptions of temporal relationships, for example, temporal precedent relationships between two events such as “after”, “subsequent to”, “before”, etc., another event may occur therebetween unless “directly after”, “directly subsequent” or “directly before” is not indicated.

When a certain embodiment may be implemented differently, a function or an operation specified in a specific block may occur in a different order from an order specified in a flowchart. For example, two blocks in succession may be actually performed substantially concurrently, or the two blocks may be performed in a reverse order depending on a function or operation involved.

It will be understood that, although the terms “first”, “second”, “third”, and so on may be used herein to describe various elements, components, regions, layers and/or periods, these elements, components, regions, layers and/or periods should not be limited by these terms. These terms are used to distinguish one element, component, region, layer or section from another element, component, region, layer or period. Thus, a first element, component, region, layer or section as described under could be termed a second element, component, region, layer or period, without departing from the spirit and scope of the present disclosure.

The features of the various embodiments of the present disclosure may be partially or entirely combined with each other, and may be technically associated with each other or operate with each other. The embodiments may be implemented independently of each other and may be implemented together in an association relationship.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In interpreting a numerical value, the value is interpreted as including an error range unless there is no separate explicit description thereof. In the context of the present disclosure, the term “about” may mean about ±1%, about ±2%, about ±3%, about ±4%, about ±5%, about ±6%, about ±7%, about ±8%, about ±9%, or about ±10% of the numerical value as recited herein.

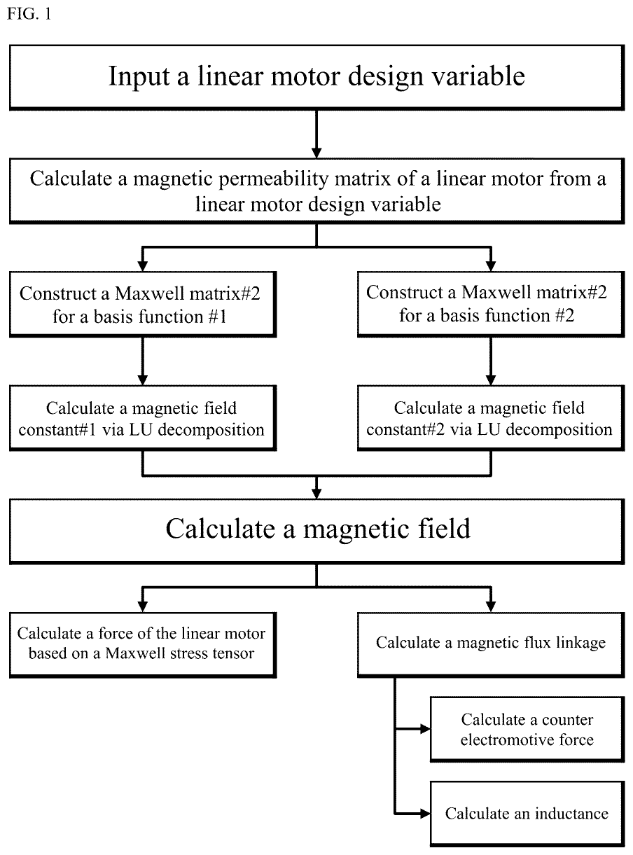

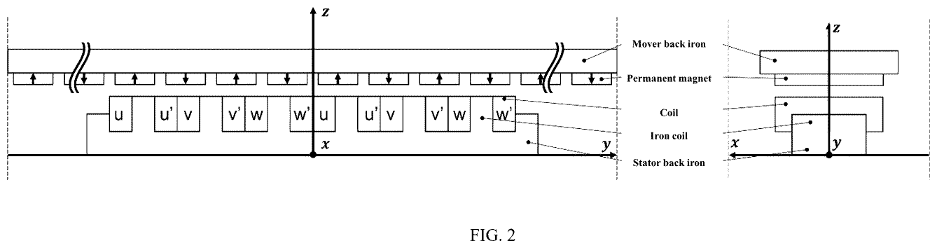

FIG. 1 is a block diagram showing an electromagnetic analysis model used in a linear motor design variable verification method according to an embodiment of the present disclosure. FIG. 2 is a linear motor that verifies a design variable through a linear motor design variable verification method according to an embodiment of the present disclosure.

Referring to FIG. 1 and FIG. 2, the linear motor design variable verification method according to an embodiment of the present disclosure and the electromagnetic analysis model used therein may receive numerical information about a motor shape, calculate a magnetic permeability matrix based on the information, construct a Maxwell matrix based on the magnetic permeability matrix, and derive a magnetic field in a motor stator from the Maxwell matrix. Based on the calculated magnetic field, electromagnetic data of the motor may be calculated. The electromagnetic data includes a motor force, a magnetic flux linkage, a counter electromotive force, and an inductance.

With continued reference to FIG. 1 and FIG. 2, the linear motor design variable verification method according to a first aspect of the present disclosure may include: a first step of deriving a magnetic permeability matrix of a linear motor from a linear motor design variable based on a following Equation (1); a second step of deriving a Maxwell matrix of the linear motor from the magnetic permeability matrix of the linear motor via LU decomposition; a third step of deriving, from the Maxwell matrix of the linear motor, at least one verification target physical quantity selected from a group including a force of the linear motor, a magnetic flux linkage passing through each of coils of a stator of the linear motor, a counter electromotive force of the linear motor, and an inductance of the linear motor; and a fourth step of comparing the derived verification target physical quantity with a predetermined reference value, and determining whether a target verification condition is satisfied, based on the comparing result:

$$\{ \begin{matrix}μ ( x , y ) cos ( {m}_{i} x ) cos ( {n}_{j} y ) = {\sum }_{k , l} {α}_{( i , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( i , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$

where x and y denote a x-coordinate and a y-coordinate of the linear motor, respectively, μ denotes a magnetic permeability of a material of the linear motor, mᵢ and nⱼ are defined as (2π/λₓ)i and (2π/λ_{y})j, respectively, mₖ and nₗ are defined as (2π/λₓ)k and (2π/λ_{y})l, respectively, λₓ and λ_{y} denote fundamental periods of a trigonometric function in an x direction and a y direction, respectively, and each of α, β, γ, ξ, ε, and ρ denotes a two-dimensional magnetic permeability matrix.

In the context of the present disclosure, the magnetic permeability may mean a physical quantity indicating how much a medium is magnetized under a given magnetic field.

The first step is a step of deriving the magnetic permeability matrix of the linear motor. In the context of the present disclosure, the magnetic permeability matrix may mean a matrix that has magnetic permeability as a component, and may be composed of Fourier coefficients when the basis functions (functions obtained via the products of trigonometric functions cos(mx), cos(ny), cos(mx), and sin(ny) in the x and y directions) multiplied by the magnetic permeability function μ(x,y) are expanded in the 2D Fourier series expansion manner.

The present disclosure is based at least on the discovery that without using the finite element method, the magnetic permeability matrix is derived, and the Maxwell matrix is derived based on the magnetic permeability matrix, and physical quantities may be calculated as approximate values within a significant level, based on the Maxwell matrix. In the context of the present disclosure, the finite element method may mean a method for obtaining approximate solutions such as partial differential equations, integrals, heat equations, etc.

The second step is a step of deriving the Maxwell matrix from the derived magnetic permeability matrix, and the third step is a step of calculating a physical quantity as the verification target from the derived Maxwell matrix. The verification target physical quantity is not limited to a specific one as long as the verification target physical quantity may be derived from the Maxwell matrix. The verification target physical quantity may include a magnetic flux linkage passing through each of coils of the stator of the linear motor, a counter electromotive force of the linear motor, an inductance of the linear motor, and a physical quantity derived therefrom.

The fourth step is a step of determining whether the calculated physical quantity has reached the target value, that is, comparing the calculated physical quantity with the predetermined reference value and determining whether the target verification condition has been satisfied, based on the comparing result. In the context of the present disclosure, the verification condition of the physical quantity being satisfied means checking whether a beneficial effect has been achieved when the calculated physical quantity is greater than or smaller than the predetermined reference value in an obvious manner to a person of ordinary skill in the art, or based on the purpose for practicing the present disclosure.

The magnetic permeability in a core portion of the iron core motor may be μₛ or μ₀ depending on the coordinates of the motor.

In accordance with some embodiments of the linear motor design variable verification method, the LU decomposition of the second step is performed based on a following Equation (2):

$$\begin{matrix}{H}_{y} = - MT {λ}_{cc}^{- 1} ( e \text{?} \text{?} \text{?} 𝕃 - e \text{?} \text{?} \text{?} 𝕄 ) sin ( {m}_{i} x ) cos ( {n}_{j} y ) - MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {H}_{y} = - NT {λ}_{cc}^{- 1} ( e \text{?} \text{?} \text{?} 𝕃 - e \text{?} \text{?} \text{?} 𝕄 ) cos ( {m}_{i} x ) sin ( {n}_{j} y ) + NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {H}_{z} = T ( e \text{?} \text{?} \text{?} 𝕃 + e \text{?} \text{?} \text{?} 𝕄 ) cos ( {m}_{i} x ) cos ( {n}_{j} y ) + U ( e \text{?} \text{?} \text{?} ℕ + e \text{?} \text{?} \text{?} 𝕆 ) cos ( {m}_{i} x ) sin ( {n}_{j} y ) \\ {B}_{x} = - {ε}^{- 1} MT {λ}_{cc}^{- 1} ( e \text{?} \text{?} 𝕃 - e \text{?} \text{?} \text{?} 𝕄 ) sin ( {m}_{i} x ) cos ( {n}_{j} y ) - {ρ}^{- 1} MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {B}_{y} = - {ξ}^{- 1} NT λ \text{?} ( e \text{?} \text{?} 𝕃 - e \text{?} \text{?} \text{?} 𝕄 ) cos ( {m}_{i} x ) sin ( {n}_{j} y ) + {γ}^{- 1} NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {B}_{z} = α T ( e \text{?} \text{?} \text{?} 𝕃 + e \text{?} \text{?} \text{?} 𝕄 ) cos ( {m}_{i} x ) cos ( {n}_{j} y ) - βU ( e \text{?} \text{?} \text{?} ℕ - e \text{?} \text{?} \text{?} 𝕆 ) cos ( {m}_{i} x ) sin ( {n}_{j} y )\end{matrix}$$

$$\text{?} \text{indicates text missing or illegible when filed}$$

where Hₓ, H_{y}, and H_{z} denote magnetic field strengths in the x direction, the y direction, and a z direction, respectively, Bₓ, B_{y}, and B_{z} denote magnetic flux densities in the x direction, the y direction, and the z direction, respectively, M and N denote diagonal matrices having the mᵢ and nⱼ as diagonal elements, respectively, T and λ_{cc} denote an eigenvector matrix and an eigenvalue matrix of {α⁻¹(Mε⁻¹M+Nξ⁻¹N)}^{1/2}, respectively, U and λ_{cs} denote an eigenvector matrix and an eigenvalue matrix of {β⁻¹(Mρ⁻¹M+Nγ⁻¹N)}^{1/2}, respectively, and each of L, M, N, and O denotes a magnetic field constant of the Maxwell matrix to be derived.

In accordance with some embodiments of the linear motor design variable verification method, in the third step, the force of the linear motor is derived based on a following Equation (3):

$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$

where Fₓ, F_{y}, and F_{z} denote forces of the linear motor in the x direction, the y direction, and a z direction, respectively, T denotes a Maxwell stress tensor, Bₓ, B_{y}, and B_{z} denote magnetic flux densities in the x direction, the y direction, and the z direction, respectively, and μ₀ denotes a magnetic permeability in vacuum.

In this regard, a significant portion of the force in the electromagnetic motor is generated in an air gap between the stator (coil section) and the mover (magnet section). Thus, [0 0−1]\hat{ }T as the normal vector of the air gap is multiplied by the Maxwell stress tensor to calculate the components Fₓ, F_{y}, and F_{z} in the x, y, and z directions of the force generated in the motor air gap.

In accordance with some embodiments of the linear motor design variable verification method, in the third step, the magnetic flux linkage passing through each of coils of the stator of the linear motor is derived based on a following Equation (4):

$$ϕ = \int B \cdot dA = \int ( ▽ \times A ) \cdot dA = ∮ A \cdot dl \qquad Equation ( 4 )$$

where ϕ denotes a magnetic flux passing through each coil, B denotes a magnetic flux density, A denotes a magnetic vector potential, and ∇×A denotes a magnetic vector potential rotation value.

In accordance with some embodiments of the linear motor design variable verification method, in the third step, the counter electromotive force of the linear motor is derived based on a following Equation (5):

$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$

where V_{bemf} denotes a counter electromotive force (back-EMF) generated in the stator due to a relative motion of the stator and mover of the linear motor, t denotes a time, yᵣ denotes a moving distance, and v denotes a velocity of the mover of the linear motor.

In this regard, under the Faraday's law, the counter electromotive force is equal to a negative value of the change of the magnetic flux passing through the coil over time. Via application of the chain rule, the change (dΦ/dt) of the magnetic flux over time may be expressed as the product of the change (d_{Φ}/dyᵣ) of the magnetic flux with respect to the moving distance and the change (dyᵣ/dt) of the moving distance with respect to time. Since the change of the moving distance with respect to time is equal to the velocity v of the mover (magnetic portion), the counter electromotive force V_{bemf} generated in the coil may be expressed as the product of the change (d_{Φ}/dyᵣ) of the magnetic flux passing through the coil relative to the moving distance and the velocity v of the mover.

In accordance with some embodiments of the linear motor design variable verification method, in the third step, the inductance of the linear motor is derived based on a following Equation (6),

$$L = ϕ I \qquad Equation ( 6 )$$

where L denotes an inductance of the stator of the linear motor, and I denotes a magnitude of a current applied to the stator of the linear motor.

A second aspect of the present disclosure provides a linear motor design variable optimization method comprising: a first step of deriving a magnetic permeability matrix of each of two or more virtual linear motors from a design variable of each of the two or more virtual linear motors, based on a following Equation (1); a second step of deriving a Maxwell matrix of each virtual linear motor from the magnetic permeability matrix of each virtual linear motor via LU decomposition; a third step of deriving, from the Maxwell matrix of each virtual linear motor, at least one verification target physical quantity selected from a group including a force of each virtual linear motor, a magnetic flux linkage passing through each of coils of a stator of each virtual linear motor, a counter electromotive force of each virtual linear motor, and an inductance of each virtual linear motor; and a fourth step of comparing the verification target physical quantity of each virtual linear motor with a target design value, and selecting the virtual linear motor having the verification target physical quantity satisfying a target verification condition of the design variable among the two or more virtual linear motors, based on the comparing result, wherein the linear motor design variable optimization method includes repeating the first step to the fourth step on two or more virtual linear motors including the linear motor selected in the fourth step at least one time:

$$\{ \begin{matrix}μ ( x , y ) cos ( {m}_{i} x ) cos ( {n}_{j} y ) = {\sum }_{k , l} {α}_{( i , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( i , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$

where x and y denote a x-coordinate and a y-coordinate of the linear motor, respectively, μ denotes a magnetic permeability of a material of the linear motor, mᵢ and nⱼ are defined as (2π/λₓ)i and (2π/λ_{y})j, respectively, mₖ and nₗ are defined as (2π/λₓ)k and (2π/λ_{y})l, respectively, λₓ and λ_{y} denote fundamental periods of a trigonometric function in an x direction and a y direction, respectively, each of α, β, γ, ξ, ε, and ρ denotes a two-dimensional magnetic permeability matrix.

The linear motor design variable optimization method according to an embodiment of the present disclosure may have the same or similar terms or configurations as those in the linear motor design variable verification method according to an embodiment of the present disclosure as described above. Thus, the descriptions about the same or similar terms or configurations of the linear motor design variable verification method according to an embodiment of the present disclosure may be equally applied to the linear motor design variable optimization method according to an embodiment of the present disclosure. In particular, the configuration of the linear motor design variable optimization method according to an embodiment of the present disclosure is similar to the configuration of the linear motor design variable verification method according to an embodiment of the present disclosure except that in the linear motor design variable optimization method, the same analysis model is applied to not a single linear motor but a plurality of linear motors in the first to third steps, and the virtual linear motor having the verification target physical quantity satisfying the target verification condition of the design variable is selected from among the two or more virtual linear motors in the fourth step. Therefore, it should be understood that the duplicate contents in the description of the linear motor design variable optimization method according to an embodiment of the present disclosure are omitted.

In the fourth step, the virtual linear motor having the verification target physical quantity satisfying the target verification condition of the design variable is selected from among the two or more virtual linear motors. The verification target physical quantity satisfying the target verification condition of the design variable may mean that a beneficial effect has been achieved when the physical quantity is greater than or smaller than the predetermined reference value in an obvious manner to a person of ordinary skill in the art, or based on the purpose for practicing the present disclosure.

Further, the linear motor design variable optimization method includes repeating the first step to the fourth step on two or more virtual linear motors including the linear motor selected in the fourth step at least one time.

In accordance with some embodiments of the linear motor design variable optimization method, the LU decomposition of the second step is performed based on a following Equation (2):

$$\begin{matrix}{H}_{y} = - MT {λ}_{cc}^{- 1} ( e \text{?} \text{?} \text{?} 𝕃 - e \text{?} \text{?} \text{?} 𝕄 ) sin ( {m}_{i} x ) cos ( {n}_{j} y ) - MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {H}_{y} = - NT {λ}_{cc}^{- 1} ( e \text{?} \text{?} \text{?} 𝕃 - e \text{?} \text{?} \text{?} 𝕄 ) cos ( {m}_{i} x ) sin ( {n}_{j} y ) + NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {H}_{z} = T ( e \text{?} \text{?} \text{?} 𝕃 + e \text{?} \text{?} \text{?} 𝕄 ) cos ( {m}_{i} x ) cos ( {n}_{j} y ) + U ( e \text{?} \text{?} \text{?} ℕ + e \text{?} \text{?} \text{?} 𝕆 ) cos ( {m}_{i} x ) sin ( {n}_{j} y ) \\ {B}_{x} = - {ε}^{- 1} MT {λ}_{cc}^{- 1} ( e \text{?} \text{?} 𝕃 - e \text{?} \text{?} \text{?} 𝕄 ) sin ( {m}_{i} x ) cos ( {n}_{j} y ) - {ρ}^{- 1} MU {λ}_{cs}^{- 1} ( e \text{?} \text{?} \text{?} ℕ - e \text{?} \text{?} \text{?} 𝕆 ) sin ( {m}_{i} x ) sin ( {n}_{j} y ) \\ {B}_{y} = - {ξ}^{- 1} NT λ \text{?} ( e \text{?} \text{?} 𝕃 - e \text{?} \text{?} \text{?} 𝕄 ) cos ( {m}_{i} x ) sin ( {n}_{j} y ) + {γ}^{- 1} NU {λ}_{cs}^{- 1} ( e \text{?} \text{?} \text{?} ℕ - e \text{?} \text{?} \text{?} 𝕆 ) cos ( {m}_{i} x ) cos ( {n}_{j} y ) \\ {B}_{z} = α T ( e \text{?} \text{?} \text{?} 𝕃 + e \text{?} \text{?} \text{?} 𝕄 ) cos ( {m}_{i} x ) cos ( {n}_{j} y ) - βU ( e \text{?} \text{?} \text{?} ℕ - e \text{?} \text{?} \text{?} 𝕆 ) cos ( {m}_{i} x ) sin ( {n}_{j} y )\end{matrix}$$

$$\text{?} \text{indicates text missing or illegible when filed}$$

where Hₓ, H_{y}, and H_{z} denote magnetic field strengths in the x direction, the y direction, and a z direction, respectively, Bₓ, B_{y}, and B_{z} denote magnetic flux densities in the x direction, the y direction, and the z direction, respectively, M and N denote diagonal matrices having the mᵢ and nⱼ as diagonal elements, respectively, T and λ_{cc} denote an eigenvector matrix and an eigenvalue matrix of {α⁻¹(Mε⁻¹M+Nξ⁻¹N)}^{1/2}, respectively, U and λ_{cs} denote an eigenvector matrix and an eigenvalue matrix of {β⁻¹(Mρ⁻¹M+Nγ⁻¹N)}^{1/2}, respectively, and each of L, M, N, and O denotes a magnetic field constant of the Maxwell matrix to be derived.

In accordance with some embodiments of the linear motor design variable optimization method, in the third step, the force of the linear motor is derived based on a following Equation (3):

$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$

where Fₓ, F_{y}, and F_{z} denote forces of the linear motor in the x direction, the y direction, and a z direction, respectively, T denotes a Maxwell stress tensor, Bₓ, B_{y}, and B_{z} denote magnetic flux densities in the x direction, the y direction, and the z direction, respectively, and μ₀ denotes a magnetic permeability in vacuum.

In accordance with some embodiments of the linear motor design variable optimization method, in the third step, the magnetic flux linkage passing through each of coils of the stator of the linear motor is derived based on a following Equation (4):

$$ϕ = \int B \cdot dA = \int ( ▽ \times A ) \cdot dA = ∮ A \cdot dl \qquad Equation ( 4 )$$

where ϕ denotes a magnetic flux passing through each coil, B denotes a magnetic flux density, A denotes a magnetic vector potential, and ∇×A denotes a magnetic vector potential rotation value.

In accordance with some embodiments of the linear motor design variable optimization method, in the third step, the counter electromotive force of the linear motor is derived based on a following Equation (5):

$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$

where V_{bemf} denotes a counter electromotive force (back-EMF) generated in the stator due to a relative motion of the stator and mover of the linear motor, t denotes a time, yᵣ denotes a moving distance, and v denotes a velocity of the mover of the linear motor.

In accordance with some embodiments of the linear motor design variable optimization method, in the third step, the inductance of the linear motor is derived based on a following Equation (6),

$$L = ϕ I \qquad Equation ( 6 )$$

where L denotes an inductance of the stator of the linear motor, and I denotes a magnitude of a current applied to the stator of the linear motor.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A linear motor design variable verification method comprising:
a first step of deriving a magnetic permeability matrix of a linear motor from a linear motor design variable based on a following Equation (1);
a second step of deriving a Maxwell matrix of the linear motor from the magnetic permeability matrix of the linear motor via LU decomposition;
a third step of deriving, from the Maxwell matrix of the linear motor, at least one verification target physical quantity selected from a group including a force of the linear motor, a magnetic flux linkage passing through each of coils of a stator of the linear motor, a counter electromotive force of the linear motor, and an inductance of the linear motor; and
a fourth step of comparing the derived verification target physical quantity with a predetermined reference value, and determining whether a target verification condition is satisfied, based on the comparing result:
$$\{ \begin{matrix}μ ( x , y ) cos ( {m}_{i} x ) cos ( {n}_{j} y ) = {\sum }_{k , l} {α}_{( i , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( i , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$
where x and y denote a x-coordinate and a y-coordinate of the linear motor, respectively,
μ denotes a magnetic permeability of a material of the linear motor,
mᵢ and nⱼ are defined as (2π/λₓ)i and (2π/λ_{y})j, respectively,
mₖ and nₗ are defined as (2π/λₓ)k and (2π/λ_{y})l, respectively,
λₓ and λ_{y} denote fundamental periods of a trigonometric function in an x direction and a y direction, respectively,
each of α, β, γ, ξ, ε, and ρ denotes a two-dimensional magnetic permeability matrix.

2. The linear motor design variable verification method of claim 1, wherein the LU decomposition of the second step is performed based on a following Equation (2):
$$\begin{matrix} & \end{matrix} \qquad Equation ( 2 )$$
$$\begin{matrix}{H}_{x} = - MT {λ}_{cc}^{- 1} ( {e}^{λ} \text{?} \text{?} \text{?} \hat{𝕃} - e \text{?} \text{?} 𝕄 ) sin ( {m}_{i} x ) cos ( {n}_{j} y ) - MU {λ}_{cs}^{- 1} ( e \text{?} \text{?} ℕ - e \text{?} \text{?} 𝕆 ) sin ( {m}_{i} x ) sin ( {n}_{j} y ) \\ {H}_{y} = - NT {λ}_{cc}^{- 1} ( {e}^{λ} \text{?} \text{?} \text{?} \hat{𝕃} + e \text{?} \text{?} 𝕄 ) cos ( {m}_{i} x ) sin ( {n}_{j} y ) + NU {λ}_{cs}^{- 1} ( e \text{?} \text{?} ℕ - e \text{?} \text{?} 𝕆 ) cos ( {m}_{i} x ) cos ( {n}_{j} y ) \\ {H}_{z} = T ( {e}^{λ} \text{?} \text{?} \text{?} \hat{𝕃} + e \text{?} \text{?} 𝕄 ) cos ( {m}_{j} x ) cos ( {m}_{i} y ) + U ( e \text{?} \text{?} ℕ + e \text{?} \text{?} 𝕆 ) cos ( {m}_{i} x ) sin ( {n}_{j} y ) \\ {B}_{y} = - \text{?} MT {λ}_{cc}^{- 1} ( {e}^{λ} \text{?} \text{?} \text{?} \hat{𝕃} - e \text{?} \text{?} 𝕄 ) sin ( {m}_{i} x ) cos ( {n}_{j} y ) - {ρ}^{- 1} MU {λ}_{cs}^{- 1} ( e \text{?} \text{?} ℕ - e \text{?} \text{?} 𝕆 ) sin ( {m}_{i} x ) sin ( {n}_{j} y ) \\ {B}_{y} = - {ξ}^{- 1} NT {λ}_{cc}^{- 1} ( {e}^{λ} \text{?} \text{?} \text{?} \hat{𝕃} - e \text{?} \text{?} 𝕄 ) cos ( {m}_{i} x ) sin ( {n}_{j} y ) + {γ}^{- 1} NU {λ}_{cs}^{- 1} ( e \text{?} \text{?} ℕ - e \text{?} \text{?} 𝕆 ) cos ( {m}_{i} x ) cos ( {n}_{j} y ) \\ {B}_{z} = α T ( {e}^{λ} \text{?} \text{?} \text{?} \hat{𝕃} + e \text{?} \text{?} 𝕄 ) cos ( {m}_{i} x ) cos ( {n}_{j} y ) + β U ( e \text{?} \text{?} ℕ + e \text{?} \text{?} 𝕆 ) cos ( {m}_{i} x ) sin ( {n}_{j} y )\end{matrix}$$
$$\text{?} \text{indicates text missing or illegible when filed}$$
where Hₓ, H_{y}, and H_{z} denote magnetic field strengths in the x direction, the y direction, and a z direction, respectively,
Bₓ, B_{y}, and B_{z} denote magnetic flux densities in the x direction, the y direction, and the z direction, respectively,
M and N denote diagonal matrices having the mᵢ and nⱼ as diagonal elements, respectively,
T and λ_{cc} denote an eigenvector matrix and an eigenvalue matrix of {α⁻¹(Mε⁻¹M+Nξ⁻¹N)}^{1/2}, respectively,
U and λ_{cs} denote an eigenvector matrix and an eigenvalue matrix of {β⁻¹(Mρ⁻¹M+Nγ⁻¹N)}^{1/2}, respectively,
each of L, M, N, and O denotes a magnetic field constant of the Maxwell matrix to be derived.

3. The linear motor design variable verification method of claim 1, wherein in the third step, the force of the linear motor is derived based on a following Equation (3):
$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$
where Fₓ, F_{y}, and F_{z} denote forces of the linear motor in the x direction, the y direction, and a z direction, respectively,
T denotes a Maxwell stress tensor,
Bₓ, B_{y}, and B_{z} denote magnetic flux densities in the x direction, the y direction, and the z direction, respectively,
μ₀ denotes a magnetic permeability in vacuum.

4. The linear motor design variable verification method of claim 1, wherein in the third step, the magnetic flux linkage passing through each of coils of the stator of the linear motor is derived based on a following Equation (4):
$$ϕ = \int B \cdot dA = \int ( ▽ \times A ) \cdot dA = ∮ A \cdot dl \qquad Equation ( 4 )$$
where ϕ denotes a magnetic flux passing through each coil,
B denotes a magnetic flux density,
A denotes a magnetic vector potential,
∇×A denotes a magnetic vector potential rotation value.

5. The linear motor design variable verification method of claim 1, wherein in the third step, the counter electromotive force of the linear motor is derived based on a following Equation (5):
$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$
where V_{bemf} denotes a counter electromotive force (back-EMF) generated in the stator due to a relative motion of the stator and mover of the linear motor,
t denotes a time,
yᵣ denotes a moving distance,
v denotes a velocity of the mover of the linear motor.

6. The linear motor design variable verification method of claim 1, wherein in the third step, the inductance of the linear motor is derived based on a following Equation (6),
$$L = ϕ I \qquad Equation ( 6 )$$
where L denotes an inductance of the stator of the linear motor,
I denotes a magnitude of a current applied to the stator of the linear motor.

7. A linear motor design variable optimization method comprising:
a first step of deriving a magnetic permeability matrix of each of two or more virtual linear motors from a design variable of each of the two or more virtual linear motors, based on a following Equation (1);
a second step of deriving a Maxwell matrix of each virtual linear motor from the magnetic permeability matrix of each virtual linear motor via LU decomposition;
a third step of deriving, from the Maxwell matrix of each virtual linear motor, at least one verification target physical quantity selected from a group including a force of each virtual linear motor, a magnetic flux linkage passing through each of coils of a stator of each virtual linear motor, a counter electromotive force of each virtual linear motor, and an inductance of each virtual linear motor; and
a fourth step of comparing the verification target physical quantity of each virtual linear motor with a target design value, and selecting the virtual linear motor having the verification target physical quantity satisfying a target verification condition of the design variable among the two or more virtual linear motors, based on the comparing result,
wherein the linear motor design variable optimization method includes repeating the first step to the fourth step on two or more virtual linear motors including the linear motor selected in the fourth step at least one time:
$$\{ \begin{matrix}μ ( x , y ) cos ( {m}_{i} x ) cos ( {n}_{j} y ) = {\sum }_{k , l} {α}_{( i , j )}^{( k , l )} cos ( {m}_{k} x ) cos ( {n}_{l} y ) \\ μ ( x , y ) cos ( {m}_{i} x ) sin ( {n}_{j} y ) = {\sum }_{k , l} {β}_{( i , j )}^{( k , l )} cos ( {m}_{k} x ) sin ( {n}_{l} y ) \\ ( \frac{1}{μ ( x , y )} ) cos ( {m}_{i} x ) cos ( {n}_{j} y ) = {\sum }_{k , l} {γ}_{( i , j )}^{( k , l )} cos ( {m}_{k} x ) cos ( {n}_{l} y ) \\ ( \frac{1}{μ ( x , y )} ) cos ( {m}_{i} x ) sin ( {n}_{j} y ) = {\sum }_{k , l} {ξ}_{( i , j )}^{( k , l )} cos ( {m}_{k} x ) sin ( {n}_{l} y ) \\ ( \frac{1}{μ ( x , y )} ) sin ( {m}_{i} x ) cos ( {n}_{j} y ) = {\sum }_{k , l} {ε}_{( i , j )}^{( k , l )} sin ( {m}_{k} x ) cos ( {n}_{l} y ) \\ ( \frac{1}{μ ( x , y )} ) sin ( {m}_{i} x ) sin ( {n}_{j} y ) = {\sum }_{k , l} {ρ}_{( i , j )}^{( k , l )} sin ( {m}_{k} x ) sin ( {n}_{l} y )\end{matrix} \qquad Equation ( 1 )$$
where x and y denote a x-coordinate and a y-coordinate of the linear motor, respectively,
μ denotes a magnetic permeability of a material of the linear motor,
mᵢ and nⱼ are defined as (2π/λₓ)i and (2π/λ_{y})j, respectively,
mₖ and nₗ are defined as (2π/λₓ)k and (2π/λ_{y})l, respectively,
λₓ and λ_{y} denote fundamental periods of a trigonometric function in an x direction and a y direction, respectively,
each of α, β, γ, ξ, ε, and ρ denotes a two-dimensional magnetic permeability matrix.

8. The linear motor design variable optimization method of claim 7, wherein the LU decomposition of the second step is performed based on a following Equation (2):
$$Equation ( 2 )$$
$$\begin{matrix}{H}_{x} = - MT {λ}_{cc}^{- 1} ( {e}^{λ} \text{?} \text{?} \text{?} \hat{𝕃} - e \text{?} \text{?} 𝕄 ) sin ( {m}_{i} x ) cos ( {n}_{j} y ) - MU {λ}_{cs}^{- 1} ( e \text{?} \text{?} ℕ - e \text{?} \text{?} 𝕆 ) sin ( {m}_{i} x ) sin ( {n}_{j} y ) \\ {H}_{y} = - NT {λ}_{cc}^{- 1} ( {e}^{λ} \text{?} \text{?} \text{?} \hat{𝕃} + e \text{?} \text{?} 𝕄 ) cos ( {m}_{i} x ) sin ( {n}_{j} y ) + NU {λ}_{cs}^{- 1} ( e \text{?} \text{?} ℕ - e \text{?} \text{?} 𝕆 ) cos ( {m}_{i} x ) cos ( {n}_{j} y ) \\ {H}_{z} = T ( {e}^{λ} \text{?} \text{?} \text{?} \hat{𝕃} + e \text{?} \text{?} 𝕄 ) cos ( {m}_{j} x ) cos ( {m}_{i} y ) + U ( e \text{?} \text{?} ℕ + e \text{?} \text{?} 𝕆 ) cos ( {m}_{i} x ) sin ( {n}_{j} y ) \\ {B}_{y} = - \text{?} MT {λ}_{cc}^{- 1} ( {e}^{λ} \text{?} \text{?} \text{?} \hat{𝕃} - e \text{?} \text{?} 𝕄 ) sin ( {m}_{i} x ) cos ( {n}_{j} y ) - {ρ}^{- 1} MU {λ}_{cs}^{- 1} ( e \text{?} \text{?} ℕ - e \text{?} \text{?} 𝕆 ) sin ( {m}_{i} x ) sin ( {n}_{j} y ) \\ {B}_{y} = - {ξ}^{- 1} NT {λ}_{cc}^{- 1} ( {e}^{λ} \text{?} \text{?} \text{?} \hat{𝕃} - e \text{?} \text{?} 𝕄 ) cos ( {m}_{i} x ) sin ( {n}_{j} y ) + {γ}^{- 1} NU {λ}_{cs}^{- 1} ( e \text{?} \text{?} ℕ - e \text{?} \text{?} 𝕆 ) cos ( {m}_{i} x ) cos ( {n}_{j} y ) \\ {B}_{z} = α T ( {e}^{λ} \text{?} \text{?} \text{?} \hat{𝕃} + e \text{?} \text{?} 𝕄 ) cos ( {m}_{i} x ) cos ( {n}_{j} y ) + β U ( e \text{?} \text{?} ℕ + e \text{?} \text{?} 𝕆 ) cos ( {m}_{i} x ) sin ( {n}_{j} y )\end{matrix}$$
$$\text{?} \text{indicates text missing or illegible when filed}$$
where Hₓ, H_{y}, and H_{z} denote magnetic field strengths in the x direction, the y direction, and a z direction, respectively,
Bₓ, B_{y}, and B_{z} denote magnetic flux densities in the x direction, the y direction, and the z direction, respectively,
M and N denote diagonal matrices having the mᵢ and nⱼ as diagonal elements, respectively,
T and λ_{cc} denote an eigenvector matrix and an eigenvalue matrix of {α⁻¹(Mε⁻¹M+Nξ⁻¹N)}^{1/2}, respectively,
U and λ_{cs} denote an eigenvector matrix and an eigenvalue matrix of {β⁻¹(Mρ⁻¹M+Nγ⁻¹N)}^{1/2}, respectively,
each of L, M, N, and O denotes a magnetic field constant of the Maxwell matrix to be derived.

9. The linear motor design variable optimization method of claim 7, wherein in the third step, the force of the linear motor is derived based on a following Equation (3):
$$\overleftrightarrow{T} = \frac{1}{{μ}_{0}} [ \begin{matrix}\frac{{B}_{x}^{2} - {B}_{y}^{2} - {B}_{z}^{2}}{2} & {B}_{x} {B}_{y} & {B}_{x} {B}_{z} \\ {B}_{x} {B}_{y} & \frac{{B}_{y}^{2} - {B}_{x}^{2} - {B}_{z}^{2}}{2} & {B}_{y} {B}_{z} \\ {B}_{x} {B}_{z} & {B}_{y} {B}_{z} & \frac{{B}_{z}^{2} - {B}_{x}^{2} - {B}_{y}^{2}}{2}\end{matrix} ] [ \begin{matrix}0 \\ 0 \\ - 1\end{matrix} ] = [ \begin{matrix}{B}_{x} {B}_{z} \\ {B}_{y} {B}_{z} \\ \frac{{B}_{z}^{2} - {B}_{x}^{2} - {B}_{y}^{2}}{2}\end{matrix} ] = [ \begin{matrix}{F}_{x} \\ {F}_{y} \\ {F}_{z}\end{matrix} ] \qquad Equation ( 3 )$$
where Fₓ, F_{y}, and F_{z} denote forces of the linear motor in the x direction, the y direction, and a z direction, respectively,
T denotes a Maxwell stress tensor,
Bₓ, B_{y}, and B_{z} denote magnetic flux densities in the x direction, the y direction, and the z direction, respectively,
μ₀ denotes a magnetic permeability in vacuum.

10. The linear motor design variable optimization method of claim 7, wherein in the third step, the magnetic flux linkage passing through each of coils of the stator of the linear motor is derived based on a following Equation (4):
$$ϕ = \int B \cdot dA = \int ( ▽ \times A ) \cdot dA = ∮ A \cdot dl \qquad Equation ( 4 )$$
where ϕ denotes a magnetic flux passing through each coil,
B denotes a magnetic flux density,
A denotes a magnetic vector potential,
∇×A denotes a magnetic vector potential rotation value.

11. The linear motor design variable optimization method of claim 7, wherein in the third step, the counter electromotive force of the linear motor is derived based on a following Equation (5):
$${V}_{bemf} = - \frac{d ϕ}{dt} = - \frac{d ϕ}{{dy}_{r}} \frac{{dy}_{r}}{dt} = - v \frac{d ϕ}{{dy}_{r}} \qquad Equation ( 5 )$$
where V_{bemf} denotes a counter electromotive force (back-EMF) generated in the stator due to a relative motion of the stator and mover of the linear motor,
t denotes a time,
yᵣ denotes a moving distance,
v denotes a velocity of the mover of the linear motor.

12. The linear motor design variable optimization method of claim 7, wherein in the third step, the inductance of the linear motor is derived based on a following Equation (6),
$$L = ϕ I \qquad Equation ( 6 )$$
where L denotes an inductance of the stator of the linear motor,
I denotes a magnitude of a current applied to the stator of the linear motor.
